(19) United States
(12) Patent Application Publication
(10) Pub. No.: US 2006/0208946 A1
(43) Pub. Date: Sep. 21, 2006

(54) SYSTEM AND METHOD FOR GLOBAL POSITIONING SYSTEM REPEATER

(76) Inventors: Jenny Ann Bailey, Cambridge (GB); Jennifer Susan Liddle, Cambridge (GB)

Correspondence Address: KNOBBE MARTENS OLSON & BEAR LLP, 2040 MAIN STREET, FOURTEENTH FLOOR, IRVINE, CA, 92614, US

(21) Appl. No.: 10/549,089

(22) PCT Filed: Sep. 29, 2003
(86) PCT No.: PCT/GB03/04223

§ 371 Date: Sep. 13, 2005

(30) Foreign Application Priority Data
Mar. 14, 2003 (GB) 0305888.0

(51) Int. Cl. G01S 5/14

(52) U.S. Cl. 342/386; 342/357.06

(57) ABSTRACT

An indoor GPS repeater unit comprising a directional receive aerial for receiving GPS signals from one or more satellites in a preselected area of the sky, a transmitting aerial for transmitting the received GPS signals; and, RF amplification means for enhancing the received GPS signals before transmitting into an indoor area is disclosed. One or more such GPS repeater units are used to reproduce the satellite constellation within buildings or underground to provide GPS coverage in these environments.

### FIELD OF THE INVENTION

This invention relates generally to improvements in or relating to satellite positioning systems, such as global positioning systems (GPS), and in particular to an indoor or subterranean location positioning system.

### BACKGROUND TO THE INVENTION

Global positioning systems (GPS) are satellite based navigation systems consisting of a network of 24 orbiting satellites 11,000 miles from the earth, the satellites are constantly moving making two complete orbits around the earth every 24 hours.

Each satellite transmits a GPS signal or message containing ‘pseudo-random code’, ephemeris and almanac data. The pseudo-random code identifies the satellite number i.e. which satellite is transmitting. Ephemeris data is constantly transmitted by each satellite consisting of current date and time. This part of the signal is essential to determining a position. The almanac data tells the GPS receiver where each GPS satellite should be at a given time throughout the day. Each satellite transmits almanac data showing orbital information for that satellite and for every other satellite in the system. The GPS receiver reads the message and saves the ephemeris and almanac data for continual use. This information can also be used to set (or correct) the clock within the GPS receiver.

The GPS receiver compares the time at which the signal was transmitted by a satellite with the time that it was received. The time difference tells the GPS receiver how far away that particular satellite is.

With a minimum of three or more satellites the GPS receiver can determine a latitude/longitude position (referred to as a two-D position fix). This can be converted into a position on the UK National Grid.

With four or more satellites the GPS receiver can determine a 3D position which includes latitude, longitude and altitude.

When using GPS the greater number of sets of known locations and distances can minimise measurement error. By continually updating a particular position a GPS receiver can accurately provide speed and direction of travel (referred to as a “ground speed” and “ground track”) of a GPS-enabled unit. GPS functionality is limited to outdoor locations where more than four satellites are visible to the GPS receiver.

GPS receiving systems have two principal functions. The first is the computation of the pseudo ranges to the various GPS satellites, and the second is the computation of the position of the receiver using these pseudo ranges, satellite timing and ephemeris data.

Conventional GPS receiving equipment is typically designed to receive GPS signals in open spaces since the satellite signals are weak microwave line-of-sight signals that can be attenuated by metal and other materials. It is desirable to provide a system that can enhance such weak signals for indoor use to achieve an optimal indoor location solution. GPS repeater systems already exist which allow location under cover but they are limited to the location of the repeater receive aerial not the actual location of the GPS receiver. By ‘indoor use’ we mean inside a building and subterranean use.

The closest prior art patent specifications known to the applicants are U.S. Pat. No. 6,266,008 (Huston et al); U.S. Pat. No. 5,959,575 (Abbott); GB 2 353 648 (Roke Manor Research Limited); and U.S. Pat. No. 5,210,540 (Masumoto).

U.S. Pat. No. 6,266,008 (Huston et al) entitled “System and Method for Determining Freight Container Locations” was filed on 4 Nov. 1994 and granted 24 Jul. 2001 is considered to be the closest prior art by the applicants and discloses a system using “pseudo satellites” (“pseudolites”) which track freight containers within warehouses-locations where the satellite view is clearly obstructed.

As disclosed in the fourth embodiment of U.S. Pat. No. 6,266,008 this system receives timing signals from the GPS constellation. The system uses this timing to create a pseudo satellite (with its own ID) and the system recreates a single signal for decoding the global positioning system.

Using this approach, high cost signal processing is required when decoding/encoding pseudo-GPS satellites and no altitude measurement is derived.

The present invention by contrast enables the use of simple aerial repeaters instead of pseudo satellites with no signal processing at all. The present invention receives the raw signals from any satellites (within a number of) particular areas of the sky and relays the signals from these satellites into the building or underground. The repeaters supplying RF amplification only.

U.S. Pat. No. 5,959,575 (Abbott) entitled ‘Interior GPS Navigation’ was filed 4 Nov. 1997 and granted 28 Sep. 1999. U.S. Pat. No. 5,959,575 discloses a system using pseudo-satellites which produce a signal similar to a satellite in the GPS constellation transmitting a new satellite identification and location. This new pseudo-satellite is received by the GPS receiver as if it was a normal satellite and the GPS' location is calculated as per normal. This system requires the use of a fixed ground transceiver at a known position to act as a reference. The present invention by contrast does not.

GB 2 353 648 (Roke Manor Research Limited) entitled ‘Repeater Unit for Satellite Positioning Systems’ was filed 6 Dec. 1999 and discloses a system which uses GPS repeaters to receive/decode signals from the GPS constellation. It then re-modulates a signal with additional information before re-transmitting the signal. Specialised receivers are required to interpret this new signal. This system is not for use within a building but to assist a mobile unit when travelling between tall buildings suffering from poor or loss of satellite signal reception due to the buildings inherent screening effect from the satellites.

The present invention needs no such specialised receivers and is specifically suited for use within a building or underground.

An object of the invention is to use directional receive aerials feeding the repeater to reproduce the satellite constellation within a building or underground allowing any GPS or GPS compatible unit to work as if it was in the open.

U.S. Pat. No. 5,210,540 (Masumoto) entitled ‘Global Positioning System’ was filed 12 Jun. 1992 and granted 11 May 1993. U.S. Pat. No. 5,210,540 discloses a system which integrates an altimeter and a GPS receiver to give a more accurate height measurement above sea level and is given by a conventional GPS receiver. Although this system produces both altitude and location readings they are for external use only not within a building.

A further object of the present invention is to provide a system that not only works in areas having a restricted or even no view of the orbiting satellites but also offers a seamless transition between the indoor and outdoor environments. It is an object of the present invention to provide such a system and method which does not implement additional signal processing or use expensive specialised equipment.

### SUMMARY OF THE INVENTION

In its broadest aspect, the invention provides an indoor GPS comprising:
A directional receive aerial for receiving GPS signals from one or more satellites in a preselected area of the sky;
A transmitting aerial for transmitting the received GPS signals; and
RF amplification means for enhancing the received GPS signals before transmitting into an indoor area.

In a subsidiary aspect of the present invention the transmitting aerial is a pre-installed ‘leaky feeder’ system thereby enabling said indoor GPS repeater unit to operate in a subterranean environment serviced by the leaky feeder system.

Advantageously, the satellite constellation is reproduced within buildings and underground providing GPS coverage in these areas.

The invention may therefore be incorporated in an indoor position location system comprising one or more indoor GPS repeater units embodying the invention.

Conveniently, location can be derived from either a room-by-room basis, a 2-D position fix basis a 3-D position fix basis.

The invention embodies a concept which is new, since none of the previously published patent specifications listed shows it.

Furthermore, none of the available documents suggests that such a system would be particularly suited to work inside buildings or tunnels or how to modify the existing systems in the way claimed by the invention.

The inventive concept thus involves an inventive step over these prior teachings.

Such an arrangement largely overcomes (or at least mitigates) the drawbacks previously listed with respect to known so-called ‘indoor’ GPS-based systems.

### BRIEF DESCRIPTION OF THE DRAWINGS

A preferred embodiment of the present invention will now be described by way of example and with reference to the accompanying drawings which:

FIGS. 1a and 1b are schematic representations of how to obtain a 2D position fix and a 3D position fix respectively,

FIG. 2 is a block diagram of a single GPS repeater,

FIGS. 3a and 3b are block schematic representations of a first embodiment showing both cross-sectional and plan views;

FIGS. 4a and 4b are block schematic representations of a second embodiment showing both cross-sectional and plan views;

FIGS. 5a and 5b are block schematic representations of a third embodiment showing both cross-sectional and plan views.

FIG. 6 shows a cross-sectional view of a fourth embodiment;

FIG. 7 shows a cross-sectional view of a variation of the embodiment shown in FIG. 6.

### DETAILED DESCRIPTION OF THE INVENTION

A system and method for indoor and subterranean navigation using GPS is described with the aim to provide any GPS enabled unit coming into the indoor or subterranean GPS repeater system's working environment with the ability to operate uninterrupted as if it was still outside.

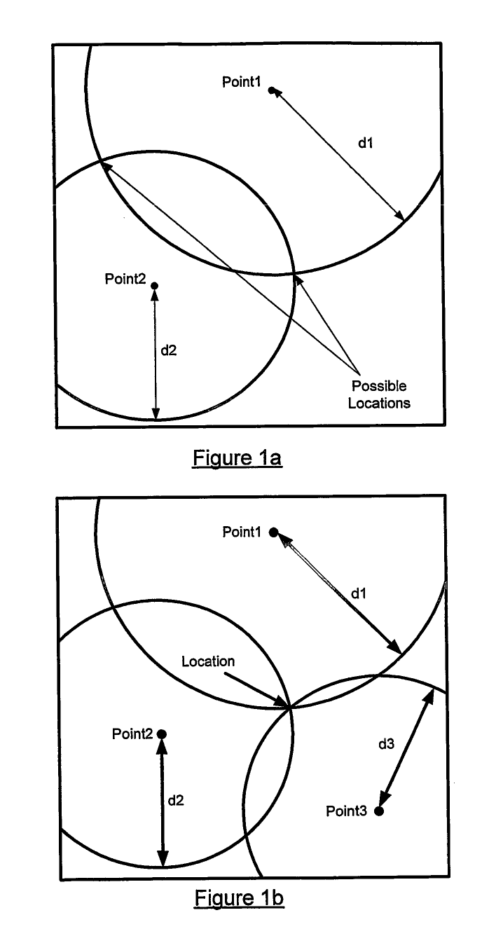

FIGS. 1a and 1b represent how satellite ranging is achieved. Signal positioning systems (GPS) use satellites in space as reference points for locations on earth. By ranging from multiple satellites it is possible to narrow down a position to just two points in space, latitude and longitude or three points in space, latitude, longitude and altitude, with more advanced systems.

FIG. 1a shows two known positions, ‘point 1’ and ‘point 2’ each sitting centrally within a circle representing all points at a known distance ‘d1’ and ‘d2’ from the known positions—much like the data that GPS units receive from orbiting satellites. There are two possible locations that are the specified distances from the two locations—where the circles overlap. One location may be discounted immediately as being improbable. FIG. 1b shows an additional point, ‘point 3’ and all positions of distance ‘d3’ from it. This additional information allows identification of a single location. Mathematically four satellite ranges are required to determine the exact position of an object. The distance from the satellite is determined by measuring how long it takes a radio frequency (RF) signal to reach the receiving system from a particular satellite.

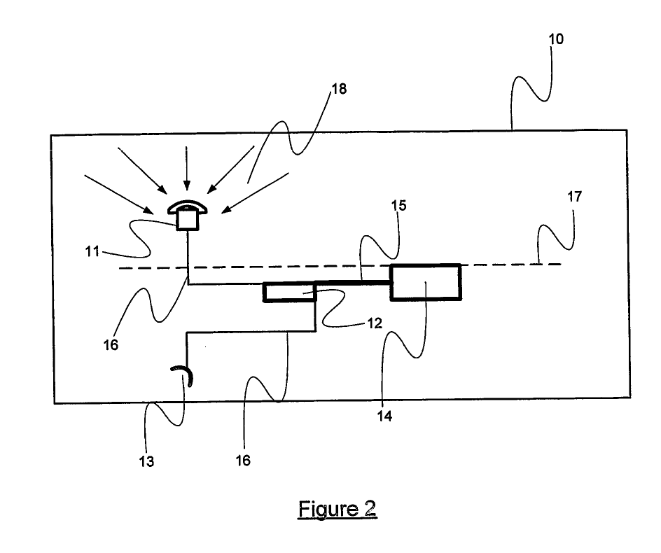

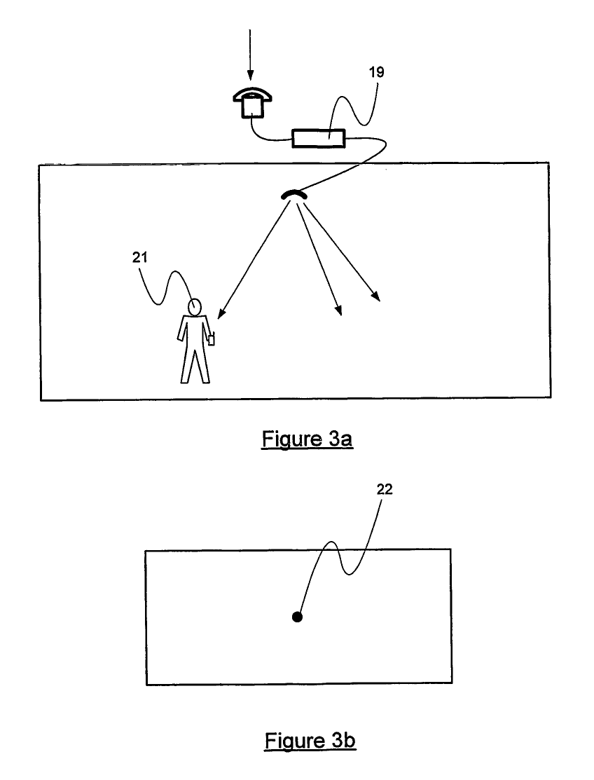

FIG. 2 is a cross-sectional block diagram of a GPS receiving system 10 which may be used to implement the method of the present invention. The GPS receiving system 10 of FIG. 2 includes a GPS receiving aerial 11, signal amplifier 12, GPS transmitting aerial 13, power supply 14, DC cable 15 and interconnecting cables 16. The GPS receiving aerial 11 is located on the roof of a building 17 and the GPS transmitting aerial 13 and the GPS repeater (see FIG. 3b) are located inside a building on the ceiling of the area of interest as shown in FIG. 3b. Used in this manner the location information is fixed to the repeater receive aerial location and is unable to give any detailed location data relating to which part of the room the GPS enabled unit is in other than whether or not it is present. A variety of units is available to perform this function.

Typically, there are twelve satellites in view at any one time when using a typical GPS receive—omni directional—aerial. The view can be narrowed by deselecting some of the GPS satellites by using directional aerials or screened aerials at the repeater. The solution provided in the present invention is to restrict the view to a small quadrant of the sky for each repeater receive aerial thereby giving each repeater its own patch of sky to be repeated into the systems working environment. Good coverage attainability is expected with four repeater units accessing different satellites to achieve latitude, longitude and altitude measurements direct from the GPS signal. Systems with two repeaters can be used for leaky feeder systems and systems with three or more repeaters can be used to cover large areas having a complex shape. It is also possible to integrate altimeters into the system for more accurately estimating for example which floor of a building the GPS receiver is located.

The system assumes a constant delay through the RF amplifier and cable within the repeater unit. The actual delay in a repeater unit is not critical but must be similar to the delay in the other repeater units.

FIG. 3a shows the directional GPS receive aerial 19 replacing the standard GPS receive aerial 11 as previously shown in FIG. 2. This is a first embodiment of the present invention providing innovative location capabilities within a ‘room’.

By ‘room’ we mean GPS coverage up to at least twenty five meters range from the repeater's indoor radiating aerial such as within a single large room or a parking bay. The result is knowing that a person or object such as, for example a person carrying an Automatic Personal Locater (APL) 21 is within the area.

The beam width of the repeater's directional receive aerial should be enough to guarantee that any satellite is not received via more than one repeater aerial. As twelve satellites are often visible, and only four are required for a 3-D fix then some gaps in the coverage of the sky is easily tolerated by the system.

As with all embodiments of the present invention allowances are made for receive aerial gain, radiating element gain, cable losses and amplifier performance and the building or test area roof is sufficient to provide isolation between the repeater receive and radiating aerials to prevent feedback.

The signal amplifier unit 12 is a standard signal amplifier suitable for use at the frequencies used by GPS systems. The GPS repeater transmitting aerial 13 is a specialised aerial radiating the frequencies used by the GPS system and directing them to the required locations within the test area. The radiation pattern is such that it assists the isolation between the repeater's receive and radiating signals. The power supply 14 and DC cable 15 is a mains power unit providing DC power to the signal amplifier 12 and associated equipment. The power supply 14 may also have a battery option or solar panel option for providing location fixes in areas with no accessible mains supply or in areas where it would be cost prohibitive to provide. The interconnecting signal cable 16 is low loss coaxial cable suitable for use with the GPS frequencies.

The repeater receiving aerial 19 is directly above the repeater radiating aerial 13. The repeater's directional receive aerial should, where possible, be situated vertically above the repeater's transmit aerial as any deviation from this position will affect the accuracy of the in-building location. Each receive unit 10 receives and amplifies the GPS signal and then re-radiated the signal into the required area.

The gain of the repeater units 10 is designed to overcome the freespace losses of the area to be covered and also the losses in the inter-coupling cable used. Allowances are made for receive aerial gain, radiating element gain and amplifier performance.

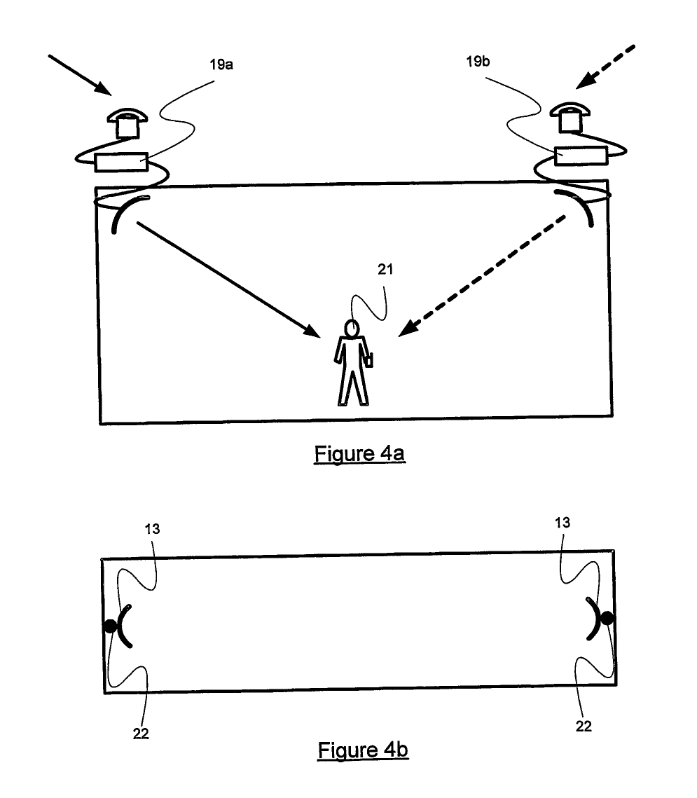

FIG. 4a is a block diagram of a second embodiment of the present invention providing location capabilities in a defined area such as a larger room, tunnel or corridor. Each repeater 22 is placed at opposite ends of the defined area and cover the entire length having a maximum range of the tunnel length. Typically the maximum length used in this configuration is 50 m.

This configuration differs from the system shown in FIG. 2 in that it uses directional or screened repeater receive aerials 19a, 19b placed at each end of the test area. Each aerial 19a, 19b is directional so that it only receives GPS signals from a controlled area of the sky. Effectively the system is selecting the satellites to be used. By using different satellites for different repeaters a GPS unit is able to determine where it is in relation to the outer walls of the area. A GPS unit is able to seamlessly proceed from the outside environment into a tunnel or corridor continue through and emerge back into the outside environment with no breaks in service.

FIG. 4b shows the plan view of this configuration showing the typical position of the repeaters 22 and GPS transmitting aerials 13.

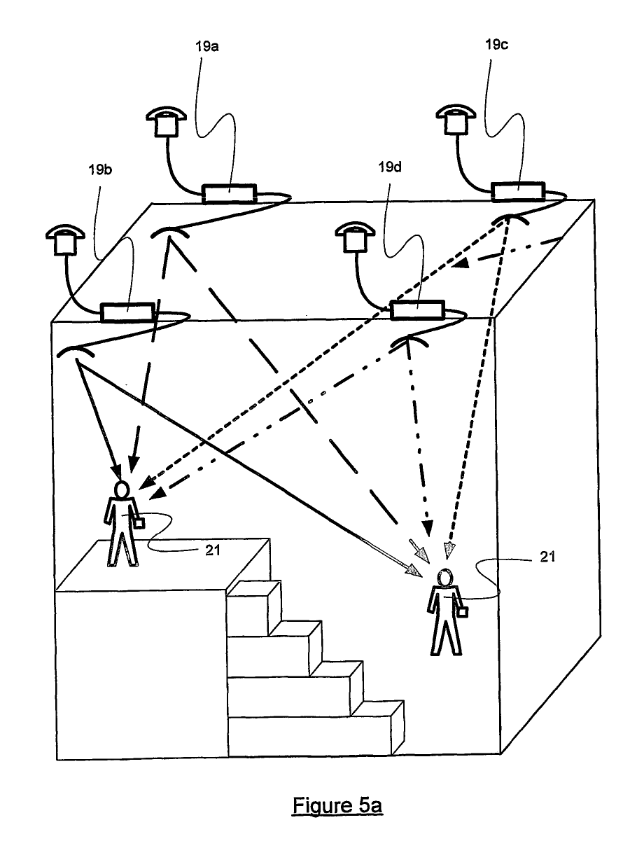

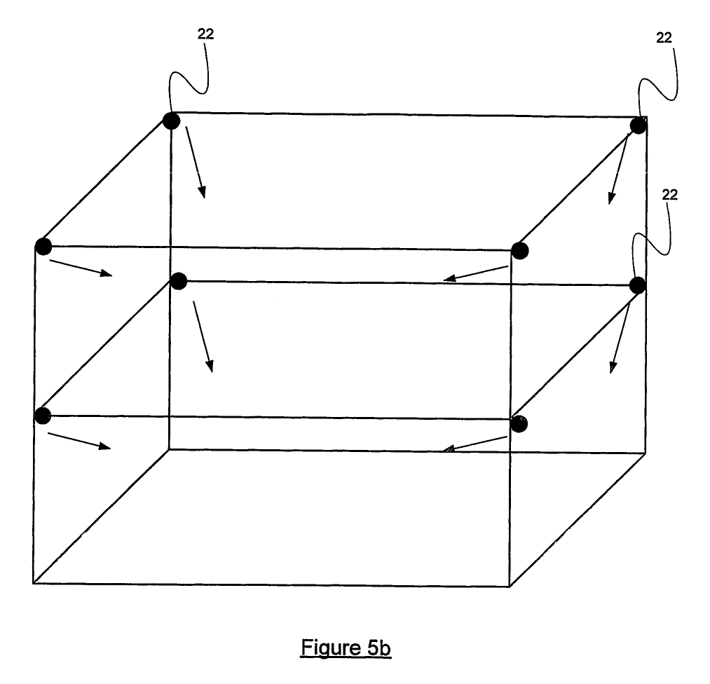

FIG. 5a is a cross-sectional block diagram of a GPS receiving system 10 of a third embodiment of the present invention providing location capabilities in a defined volume such as an indoor space of 75 meters square by 30 m high for example in a shopping mall or in an airport terminal.

A repeater unit 19a, 19b, 19c, 19d is provided at each corner of the roof area and at each top corner of each successive volume providing three-dimensional location capabilities to determine which part of the volume the GPS unit is in i.e. where it is (latitude and longitude) including floor details. The idea behind this configuration is to establish not only where the person or object is in relation to the outer walls of a building but also what floor or level they are on. Typically having an accuracy of within 5 m horizontally and within a floor (typically 4 m) vertically.

FIG. 5b is a simplified version of FIG. 5a just showing the position of the repeaters 22.

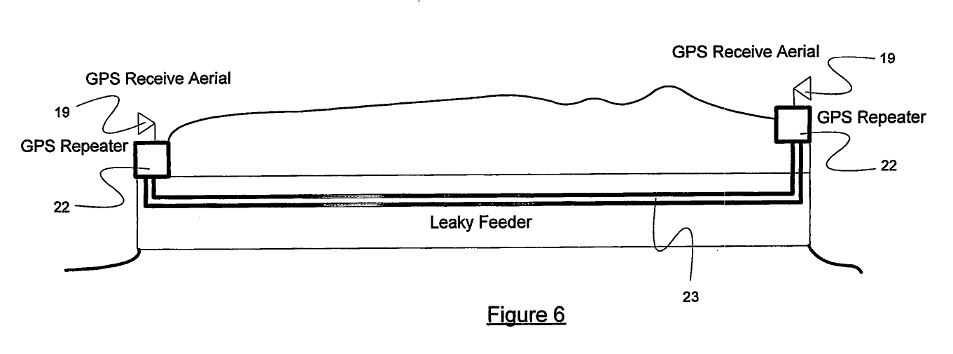

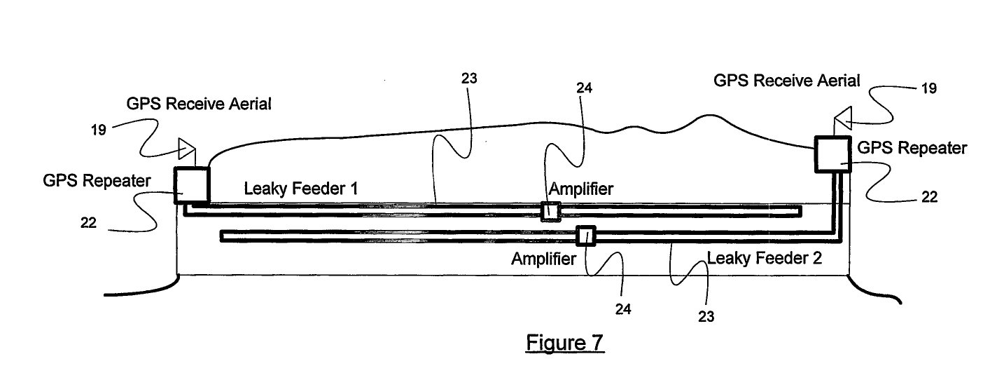

FIG. 6 shows a fourth embodiment of the present invention where a long thin room or tunnel is serviced using a standard leaky feeder 23 system. This embodiment uses only two repeater 22 stations transmitting the amplified GPS signal down the same leaky feeder 23.

FIG. 7 shows a variation of the previous embodiment where a very long thin room or tunnel is serviced using two or more leaky feeder 23 systems including regularly spaced line amplifiers 24 to boost the GPS signal during transit. In a system such as this to be used in a tunnel with two or more repeaters 22 the reported location may be accurate in one dimension but inaccurate in two or three dimensions. As the geography of the subterranean area is well known the reported location can be corrected at the application level. Inaccuracies in the system using three or more repeaters can be mitigated at the application level as the location of the satellites are known as is the relative path distortions via the repeaters.

Thus there has been disclosed an indoor personal location system combining radio telephoning and GPS suitable for individual use including emergency service use to provide three levels of operation:
room-by-room (is there anybody there?);
two-dimensional location (latitude and longitude) indicating position within a given area;
three-dimensional location (latitude, longitude and altitude) indicating position and floor number.

Typical uses of this indoor GPS repeater include the following applications:
Indoor GPS location system operation (as if outdoors);
Use in vehicle bays and tunnels for vehicle mounted systems;
Indoor test and demonstration of GPS receivers;
Ability of mobile phone fitted with GPS to determine their position indoors (such as the E911 requirement); and
Increased location ability to all public safety utilities.

The benefits of this GPS repeater system and method include:
Accurate indoor and/or subterranean location positioning method using handheld GPS;
In-built altitude measurement;
Use of directional aerials selecting which satellites are repeated and transmitted into the indoor building environment;
Elimination of ‘loss of location’ errors during transition between outdoors indoors and vice versa.

The intended skilled addressee of this disclosure can supply, without inventive thought, any more detailed knowledge needed to put the invention into practice.

The method and system as described herein are compatible with both GPS and the Russian Ministry of Defence version of GPS—GLONASS (Global Orbiting Navigation Satellite System) and the next generation of GPS systems such as, for example, Galileo.

The scope of the invention is defined by the Claims which now follow.

1-5. (canceled)

6. An indoor position location system, comprising:
a plurality of indoor GPS repeater units with a plurality of receive aerials, located at different spaced apart points about an indoor area, for receiving signals from at least one satellite; and
a transmitting aerial for transmitting the received GPS signals,
wherein each repeater unit incorporates an RF amplifier configured to enhance the received GPS signals before transmitting into an indoor area; and
wherein at least two of the receive aerials are directional receive aerials whose view is restricted so as to cover different preselected sections of the sky, thereby the first receive aerial receives GPS signals from at least a first group of at least one satellite in a preselected section of the sky and the second receive aerial receives GPS signals from at least a second group of at least one satellite in a second preselected section of the sky.

7. The indoor position location system according to claim 6, wherein the GPS repeater units only apply RF amplification to the repeated signal.

8. The indoor position location system according to claim 6, wherein the transmitting aerial is a pre-installed leaky feeder system thereby enabling said indoor GPS repeater unit to operate in a subterranean environment serviced by the leaky feeder system.

9. The indoor position location system according to claim 6, further comprising at least four repeater aerials accessing signals from four separate groups of at least one satellite.

10. The indoor position location system according to claim 6, wherein each directional receive aerial has a beam width selected to guarantee that any satellite is not received via more than one repeater aerial.
